(19) United States
(12) Patent Application Publication
(10) Pub. No.: US 2026/0071905 A1
(43) Pub. Date: Mar. 12, 2026

(54) SENSOR

(71) Applicant: Kuwanan Metals, Ltd., Kuwana-shi (JP)

(72) Inventor: Akira Sasaki, Mie-gun (JP)

(73) Assignee: Kuwana Metals, Ltd., Kuwana-shi (JP)

(21) Appl. No.: 19/107,635

(22) PCT Filed: Jul. 25, 2023
(86) PCT No.: PCT/JP2023/027172

§ 371 Date: Feb. 28, 2025

(30) Foreign Application Priority Data
Sep. 1, 2022 (JP) 2022-138891

(51) Int. Cl. G01F 1/684; G01F 15/14

(52) U.S. Cl. CPC G01F 1/6842; G01F 15/14

(57) ABSTRACT

A sensor comprising one, two or more sensor elements; a first flow channel that is a flow channel which delivers fluid from the outside of the sensor to a position of the sensor element; and a second flow channel that is a flow channel which returns the fluid delivered to the position of the sensor element by the first flow channel to the outside of the sensor. The sensor may comprise a protection tube having one end closed and the other end open, and the sensor elements may be located inside the protection tube. In this case, the sensor elements are located in at least one of the first flow channel or the second flow channel. At least one of a member of the first flow channel and a member of the second flow channel may have a lower thermal conductivity than a member of the protection tube.

### FIELD

The present invention relates to a sensor used at high temperatures.

### BACKGROUND ART

For example, in the manufacturing process of semiconductor devices such as integrated circuits, various types of semiconductor material gases (which will be referred to as “material gases” hereinafter) are used depending on the purpose of the process. As for material gases whose precursors are stored in a liquid or solid state, the precursor is converted to a gaseous material gas using a vaporizer, and thereafter supplied to a semiconductor manufacturing apparatus via piping. As means for generating a material gas from a precursor in a vaporizer, a method of heating the precursor stored in a tank to generate vapor can be exemplified.

Moreover, in association with progresses in integrated circuit manufacturing technology, new material gases which have a lower equilibrium vapor pressure than conventional material gases and are therefore less likely to vaporize are more frequently used (for example, refer to Japanese Patent Application Laid-Open (kokai) No. 2009-074108). In a case where such a new material gas is used, when the temperature of the material gas decreases during the process of supplying the material gas from a vaporizer to a semiconductor manufacturing apparatus, there is a possibility that the material gas may condense or sublimate and return to a liquid or solid precursor state or the precursor adhering to an inner wall of a flow channel of the material gas may dry and solidify and then peel off from the inner wall to cause particles. Therefore, for the purpose of preventing the material gas from condensing and solidifying within the flow channel, attempts have been made to provide a heater around the flow channel of the material gas to heat the flow channel.

As mentioned above, recently, the temperature of the precursor and/or material gas in the vaporizer has tended to rise higher and higher.

On the other hand, a vaporizer is generally equipped with a valve for starting or stopping supply of a generated material gas, a flow controller for controlling a flow rate of the material gas and various sensors for detecting the amount of a precursor and properties (for example, temperature and pressure, etc.) of the material gas, and the like. For example, in a liquid level sensor for detecting the amount of a precursor in a liquid state, a sensor element such as a Hall IC or a reed switch is used to detect the liquid level of the precursor. Not only Hall ICs and reed switches, but many sensor elements have a maximum operating temperature that is the upper limit of the operating temperature at which they can be used for a long period of time while maintaining normal operation.

For example, a semiconductor element having a pn junction at which a p-type semiconductor and an n-type semiconductor are joined is widely used as a sensor since its electrical conductivity changes greatly depending on the surrounding environment. A sensor using a semiconductor element is referred to as a semiconductor sensor. There are a wide variety of semiconductor sensors, including, but not limited to, temperature sensors, optical sensors, magnetic field sensors, pressure sensors and acceleration sensors, and the like.

In International Patent Publication No. WO2022/004739 filed by the present applicant, an invention of a liquid level sensor which detects the level of liquid is disclosed. This liquid level sensor comprises a sleeve installed vertically, a float configured to move along the sleeve in accordance with fluctuations in the liquid level, a resistor array and a plurality of grounding means constituted by Hall ICs. The Hall IC is a type of semiconductor sensor and functions as a magnetic field sensor and grounds the resistor array at the position where the float is present when detecting a magnetic field generated by the magnet included in the float. In this configuration, since an electrical signal generated in the resistor array changes in accordance with the fluctuations in the liquid level, the liquid level can be detected by extracting the electrical signal.

Temperature at the pn junction of a semiconductor element is referred to as “junction temperature.” When the junction temperature exceeds a certain limit temperature, a large number of electron-hole pairs are generated, it becomes impossible for the semiconductor element to operate normally. This limit temperature is referred to as “maximum junction temperature.” The maximum junction temperature of a typical semiconductor element is approximately 170° C. in a case of temporary heating. However, in order to ensure long-term reliability of semiconductor sensors, it is recommended to maintain the temperature of the pn junction (junction temperature) at a temperature which does not exceed a predetermined temperature (for example, 100° C.) that is sufficiently lower than the maximum junction temperature. When a semiconductor sensor continues to be used for a long period of time in an environment where the junction temperature exceeds such a predetermined temperature, it is necessary to replace the semiconductor sensor with an unused semiconductor sensor for a short period of time for the purpose of preventing malfunctions.

Moreover, a plurality of the grounding means which the liquid level sensor comprises may be constituted by reed switches instead of Hall ICs which are a type of semiconductor sensor as described above. As is well known to those skilled in the art, a reed switch is constituted by two magnetic reeds whose free ends are held apart with a predetermined interval inside a glass tube or the like. A reed switch is configured such that the reeds are magnetized and their free ends attract each other and come into contact to close a circuit when a magnetic field is applied from the outside, and their free ends are separated from each other due to the elasticity of the reeds when the magnetic field disappears.

Therefore, for example, when the temperature of the reed switch reaches a temperature which exceeds the Curie temperature of the material constituting the reeds, there is a possibility that the magnetism of the reed may change and it may become impossible for the reed switch to operate normally. Moreover, depending on the temperature, there is a possibility that the elastic modulus of the material forming the reeds changes and it may become impossible for the reed switch to operate normally.

In this way, not only semiconductor sensors but also many sensor elements including reed switches have a maximum operating temperature that is an upper limit of the operating temperature at which they can be used for a long period of time while maintaining normal operation. Therefore, in order to continue using a sensor for a long period of time without replacing it, it is preferable to maintain the operating temperature of the sensor so as not to exceed the maximum operating temperature of the sensor element.

### SUMMARY

An aspect may be characterized as a sensor used in a vaporizer, the sensor comprising one, two or more sensor elements; a first flow channel that is a flow channel which delivers fluid from the outside of said sensor to a position of said sensor element; and a second flow channel that is a flow channel which returns said fluid delivered to said position of said sensor element by said first flow channel to the outside of said sensor. Among members constituting said vaporizer, at least a member in which said sensor is disposed is housed inside a housing, said vaporizer is configured such that the inside of said housing is purged by flowing an inert gas inside said housing, and said sensor is configured such that at least a part of said inert gas flows through said first flow channel and said second flow channel as said fluid.

Another aspect may be characterized as a sensor used in a vaporizer comprising one, two or more sensor elements; a first flow channel that is a flow channel which delivers fluid from the outside of said sensor to a position of said sensor element; and a second flow channel that is a flow channel which returns said fluid delivered to said position of said sensor element by said first flow channel to the outside of said sensor. Said fluid is not a gas obtained by vaporizing a precursor with said vaporizer, said sensor further comprises a protection tube having one end closed and the other end open, said sensor elements are located inside said protection tube, said first flow channel is configured so as to deliver said fluid from a position of said other end of said protection tube to a position of an endmost sensor element that is said sensor element closest to said one end of said protection tube among said sensor elements, said second flow channel is configured so as to return said fluid delivered to the position of said endmost sensor element by said first flow channel to the position of said other end, and said sensor elements are located in at least one of said first flow channel or said second flow channel. Both of a member constituting said first flow channel and a member constituting said second flow channel are formed of a material having lower thermal conductivity than thermal conductivity of a member constituting said protection tube, said first flow channel is located inside said second flow channel, and said protection tube does not constitute a flow channel of the fluid.

Yet another aspect may be characterized as a liquid level sensor used in a vaporizer, which comprises: a protection tube having one end closed and the other end open and installed so as to extend vertically; one, two or more sensor elements located inside said protection tube; a first flow channel that is a flow channel configured so as to deliver fluid from a position of said other end of said protection tube to a position of an endmost sensor element that is said sensor element closest to said one end of said protection tube among said sensor elements; a second flow channel that is a flow channel configured so as to return said fluid delivered to the position of said endmost sensor element by said first flow channel to the position of said other end of said protection tube; and a float comprising a magnet and configured so as to move along said protection tube in association with fluctuations in the liquid level of a precursor which becomes a gas by being vaporized by said vaporizer. Said sensor elements are located in at least one of said first flow channel or said second flow channel, and among members constituting said vaporizer, at least a member in which said sensor is disposed is housed inside a housing. Said vaporizer is configured such that the inside of said housing is purged by flowing an inert gas inside said housing, and said sensor is configured such that at least a part of said inert gas flows through said first flow channel and said second flow channel as said fluid.

### BRIEF DESCRIPTION OF DRAWINGS

FIG. 1 is a schematic diagram for showing an example of a configuration of a sensor according to the present invention in a first embodiment of the present invention.

FIG. 2 is a schematic diagram for exemplifying a configuration of a sensor according to a preferred first embodiment of the present invention.

FIG. 3 is a schematic diagram for exemplifying a configuration of a sensor according to a second embodiment of the present invention.

FIG. 4 is a partial cross-sectional view for showing an example of a liquid level sensor according to the present invention.

FIG. 5 is an erection diagram of a vaporizer comprising the liquid level sensor exemplified in FIG. 4.

FIG. 6 is a front view for showing an example of a main part of a liquid level sensor according to the present invention.

FIG. 7 is a partial cross-sectional view for showing an example of a liquid level sensor according to the prior art.

### DETAILED DESCRIPTION

### Technical Problem

As mentioned above, in order to continue using a sensor for a long period of time without replacing the sensor, it is preferable to maintain the operating temperature of the sensor so as not to exceed the maximum operating temperature of a sensor element. However, in some applications of the sensor, there is a need to continuously use the sensor at a high temperature exceeding the maximum operating temperature. As an example, a liquid level sensor comprising the above-mentioned Hall IC or reed switch may be provided in a tank of a vaporizer. As mentioned above, a vaporizer is a device used for the purpose of supplying a material gas to semiconductor manufacturing apparatus and the like. A liquid material as a precursor which is the source of the material gas is stored in the tank of the vaporizer, and the liquid level is measured by a liquid level sensor.

When a method of heating a liquid material stored in a tank is adopted as a method of vaporizing a material gas, a liquid level sensor in contact with the liquid material in the tank is usually also heated to the same temperature as the liquid material. Some liquid materials cannot obtain vapor pressure required for supplying the material gas unless they are heated to a temperature exceeding the maximum operating temperature of the sensor element. However, as described above, from the viewpoint of ensuring long-term reliability of the sensor, it was necessary to maintain the operating temperature of the sensor so as not to exceed the maximum operating temperature of the sensor element. For example, in a vaporizer equipped with a liquid level sensor constituted by a semiconductor element having a pn junction, from the viewpoint of ensuring long-term reliability, there was a problem that the liquid material could not be heated and vaporized at a temperature which exceeds a predetermined temperature (for example, 100° C.) sufficiently lower than the maximum junction temperature.

The present invention has been conceived in view of the above-mentioned problems, and one objective of the present invention is to provide a sensor which can be used continuously for a long period of time at a temperature exceeding the maximum operating temperature of a sensor element constituting the sensor.

### Solution to Problem

The sensor according to the present invention is a sensor used in a vaporizer, and comprises one, two or more sensor elements, a first flow channel that is a flow channel which delivers fluid from the outside of the sensor to a position of the sensor element and a second flow channel that is a flow channel which returns the fluid delivered to the position of the sensor element by the first flow channel to the outside of the sensor. Furthermore, the fluid is not a gas obtained by vaporizing a precursor with the vaporizer.

In this configuration, the sensor element is cooled by the fluid flowing through the first flow channel and the second flow channel. Thereby, even when the temperature outside the sensor rises to a temperature exceeding the maximum operating temperature of the sensor element, the temperature of the sensor element can be maintained at a temperature lower than the temperature outside the sensor.

In a preferred embodiment, the sensor according to the present invention further comprises a protection tube having one end closed and the other end open, and the sensor element is located inside the protection tube. In this case, at least one of a member constituting the first flow channel and a member constituting the second flow channel may be formed of a material having lower thermal conductivity than that of a member constituting the protection tube. In this configuration, since it becomes difficult for heat to be transmitted from the outside to the inside of the protection tube, a rise in temperature of the sensor element can be suppressed more reliably. Moreover, the sensor according to the present invention can be configured as a liquid level sensor used in a vaporizer.

### Advantageous Effects of Invention

As described above, in the present invention, the sensor element is cooled by the fluid flowing through the first flow channel and the second flow channel. Thereby, even when the temperature outside the sensor rises to a temperature exceeding the maximum operating temperature of the sensor element, the temperature of the sensor element can be maintained at a temperature lower than the temperature outside the sensor. Therefore, the temperature at which the sensor comprising the sensor element is used continuously over a long period of time can be set to a higher temperature than before. Thereby, the operating temperature of a vaporizer which uses a liquid level sensor comprising a sensor element can be set to a higher temperature than the maximum operating temperature of the sensor element.

### DESCRIPTION OF EMBODIMENTS

Embodiments for carrying out the present invention will be explained in detail below. The following explanation and drawings are intended to show embodiments for carrying out the present invention, and the embodiments for carrying out the present invention are not limited to the embodiments shown in the following explanation and drawings.

### First Embodiment

In a first embodiment, the present invention is an invention of a sensor used in a vaporizer, which comprises one, two or more sensor elements, a first flow channel that is a flow channel which delivers fluid from the outside of the sensor to a position of the sensor element and a second flow channel that is a flow channel which returns the fluid delivered to the position of the sensor element by the first flow channel to the outside of the sensor and uses, as the above-mentioned fluid, fluid that is not a gas obtained by vaporizing a precursor with the vaporizer.

The sensor element which the sensor according to the present invention comprises is an element for detecting the amount of a precursor of a material gas stored in a tank installed inside a vaporizer or properties (for example, temperature and pressure, etc.) of the material gas, and the like, for example. As mentioned above, many sensor elements have a maximum operating temperature that is the upper limit of the operating temperature at which they can be used for a long period of time while maintaining normal operation. Therefore, in order to continue using a sensor for a long period of time without replacing it, it is necessary to maintain the operating temperature of the sensor so as not to exceed the maximum operating temperature of the sensor element.

As specific examples of sensor elements as mentioned above, semiconductor elements including Hall ICs, reed switches and the like can be exemplified. The semiconductor element which the sensor according to the present invention comprises is a semiconductor element having a pn junction. As mentioned above, since a semiconductor element having a pn junction has electrical conductivity which changes greatly depending on the surrounding environment, it can function as a sensor. As the semiconductor element according to the present invention, for example, an optical sensor, a magnetic field sensor, a pressure sensor, an acceleration sensor, and the like can be used. However, the semiconductor element according to the present invention is not limited to these sensors.

Moreover, the semiconductor element which the sensor according to the present invention comprises is not limited to an element in which only a part functioning as a sensor is constituted by a semiconductor having a pn junction. For example, it may be an element in which, whereas a sensor element itself is not a semiconductor, an amplifier or other peripheral circuitry associated with the sensor is constituted by a semiconductor. Alternatively, it may be an element in which both the sensor part and the peripheral circuitry are constituted by semiconductors.

In addition, the number of the sensor elements which the sensor according to the present invention comprises may be one, two or more. When the sensor according to the present invention comprises two or more sensor elements, all the sensor elements may be of the same type, or different types of sensor elements may be mixed.

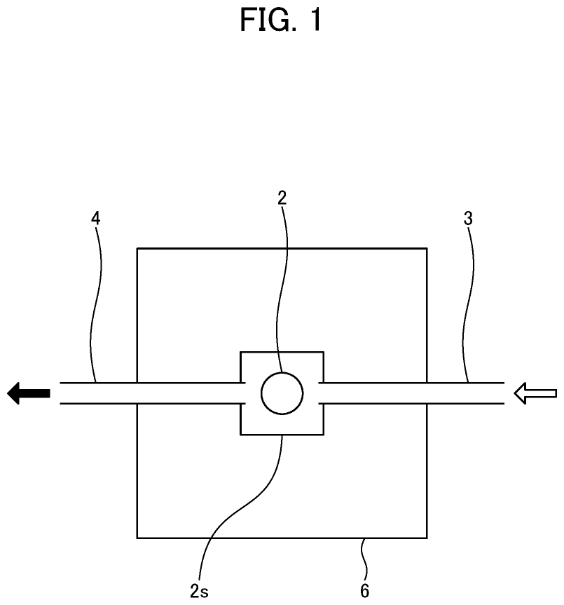

FIG. 1 is a schematic diagram for showing an example of a configuration of a sensor according to the present invention in the first embodiment. As exemplified in FIG. 1, the sensor 2s according to the present invention comprises a first flow channel 3 that is a flow channel which delivers fluid from the outside of the sensor 2s to a position of the sensor element 2 and a second flow channel 4 that is a flow channel which returns the fluid delivered to the position of the sensor element 2 by the first flow channel 3 to the outside of the sensor 2s, as described above. The first flow channel 3 and the second flow channel 4 only need to be configured as a continuous space respectively, and the shapes of these spaces are not limited. It is preferable that the shapes of the spaces constituting the first flow channel 3 and the second flow channel 4 are shapes in which there is little fluid resistance and the flow of fluid is less likely to be obstructed. The first flow channel 3 and the second flow channel 4 may be directly connected to each other at the position of the sensor element 2, or they may be indirectly connected via a transition section which is neither the first flow channel 3 nor the second flow channel 4 as exemplified in FIG. 1. Each of the first flow channel 3 and the second flow channel 4 may be one system, or each may branch midway into a plurality of systems, or the plurality of the systems may merge again.

The first flow channel 3 is a flow channel which delivers fluid from the outside of the sensor 2s to the position of the sensor element 2. However, the first flow channel 3 itself does not necessarily have to reach the position of the sensor element 2 from outside the sensor 2s. For example, when there is another flow channel which guides the fluid to be delivered to the position of the sensor element 2 from the outside of the sensor 2s to the inside of the sensor 2s, the fluid may be delivered to the position of the element 2 via this flow channel and the first flow channel 3. Moreover, even when the end of the first flow channel 3 on the side of the sensor element 2 does not reach the position of the sensor element 2, it is sufficient that the flow of the fluid released from the first flow channel 3 reaches the sensor element 2 to attain a cooling effect.

On the other hand, the second flow channel 4 is a flow channel which returns the fluid delivered to the position of the sensor element 2 by the first flow channel 3 to the outside of the sensor 2s. However, the second flow channel 4 itself does not necessarily need to reach from the position of the sensor element 2 to the outside of the sensor 2s, either. For example, when there is another flow channel which guides the fluid delivered to the position of the sensor element 2 from the inside to the outside of the sensor 2s, the fluid delivered to the position of the sensor element 2 by the first flow channel 3 may be returned to the outside of the sensor 2s via this flow channel and the second flow channel 4. Moreover, even when the end of the second flow channel 4 on the side of the sensor element 2 does not reach the position of the sensor element 2, it is sufficient that the flow of the fluid delivered to the position of the sensor element 2 by the first flow channel 3 and warmed as a result of cooling the sensor element 2 is guided away from the position of the sensor element 2 to the outside of the sensor 2s via the second flow channel 4.

By the above-mentioned actions of the first flow channel 3 and the second flow channel 4, heat is removed from the sensor element 2 by the fluid as a heat medium, and the heat is released to the outside of the sensor 2s. Either one or both of the first flow channel 3 and the second flow channel 4 according to the present invention may be constituted by an independent tubular member, or the first flow channel 3 and the second flow channel 4 may be constituted integrally by a single member.

When operating the sensor 2s according to the present invention to perform sensing, fluid is supplied to the first flow channel 3 as shown by the white arrow in FIG. 1, and the fluid is discharged or recovered from the second flow channel 4 as shown by the black arrow in FIG. 1 at the same time. As mentioned above, the fluid used when using the sensor 2s according to the present invention is not a gas obtained by vaporizing a precursor with a vaporizer to which the sensor 2s according to the present invention is applied. As such fluid, any fluid may be used as long as it has the effect of cooling the sensor element 2, and any fluid which is generally used as a coolant can be used. It is preferable that the fluid used to carry out the present invention is a stable substance which has a large heat capacity, is easy to handle and is unlikely to chemically react with the walls of the first flow channel 3 and the second flow channel 4. Specifically, water, air or an inert gas such as nitrogen gas is preferred as the fluid used to practice the present invention. In order to obtain the effect of cooling the sensor element 2 according to the present invention, the temperature of the fluid supplied to the sensor 2s needs to be lower than the temperature around the sensor element 2.

In the sensor 2s according to the present invention having the above-mentioned configuration, the sensor element 2 comes into contact with the fluid delivered to the position of the sensor element 2 by the first flow channel 3. A part of the heat transferred from the periphery of the sensor element 2 toward the sensor element 2 is carried away from the position of the sensor element 2 to the outside by the flow of the fluid. Moreover, in general, the power consumption of the sensor element 2 is extremely small and the amount of heat generated by the sensor element 2 itself is small. Therefore, the temperature of the sensor element 2 approximately coincides with the temperature of the fluid that is the temperature of the periphery of the sensor element 2. As a result, even when the temperature around the sensor 2s exceeds the maximum operating temperature of the sensor element 2, the temperature of the sensor element 2 can be maintained at a temperature lower than the temperature around the sensor 2s. Thereby, it is possible to prevent malfunctions and/or acceleration of aging deterioration due to temperature rise of the sensor element. Therefore, in accordance with the present invention, it is possible to provide the sensor 2s which can be used continuously for a long period of time at a temperature exceeding the maximum operating temperature of the sensor element 2 constituting the sensor 2s.

In the example shown in FIG. 1, the sensor 2s comprising the sensor element 2 is disposed inside a tank 6 in which a precursor of a material gas supplied by a vaporizer (not shown) is housed. However, the arrangement of the sensor 2s in the vaporizer is not limited to the example shown in FIG. 1, and the sensor 2s can be located at any suitable position such as the surface or inside of the members constituting the vaporizer, for example.

By the way, in this technical field, for the purpose of explosion protection in a vaporizer which supplies a flammable material gas, for example, a vaporizer housed inside a housing and configured to purge the inside of the housing by flowing an inert gas inside the housing is known. In such a vaporizer, it would be desirable if the inert gas for purging could also be used to cool the sensor element, since this could prevent the configuration of the vaporizer from becoming more complicated and/or to prevent the manufacturing cost of the vaporizer from increasing.

Therefore, in a preferred first embodiment, the sensor according to the present invention is the above-mentioned sensor wherein, among members constituting the vaporizer, at least a member in which the sensor is disposed is housed inside a housing, the vaporizer is configured such that the inside of the housing is purged by flowing an inert gas inside the housing, and the sensor is configured such that at least a part of the inert gas flows through the first flow channel and the second flow channel as the above-mentioned fluid.

In this embodiment, as specific examples of the inert gas used as the fluid for cooling the sensor element, argon gas, nitrogen gas and the like can be exemplified. However, from the viewpoint of reducing operating costs, nitrogen gas is preferred. Moreover, in this embodiment, the vaporizer already comprises a mechanism for supplying the inert gas from the outside to the inside of the housing and discharging the inert gas from the inside to the outside of the housing. Therefore, by supplying the inert gas for purging from a supply flow channel of the inert gas for purging to the first flow channel and discharging the inert gas from the second flow channel via a discharge flow channel of the inert gas for purging, one can easily construct a flow channel of the fluid for cooling the sensor element.

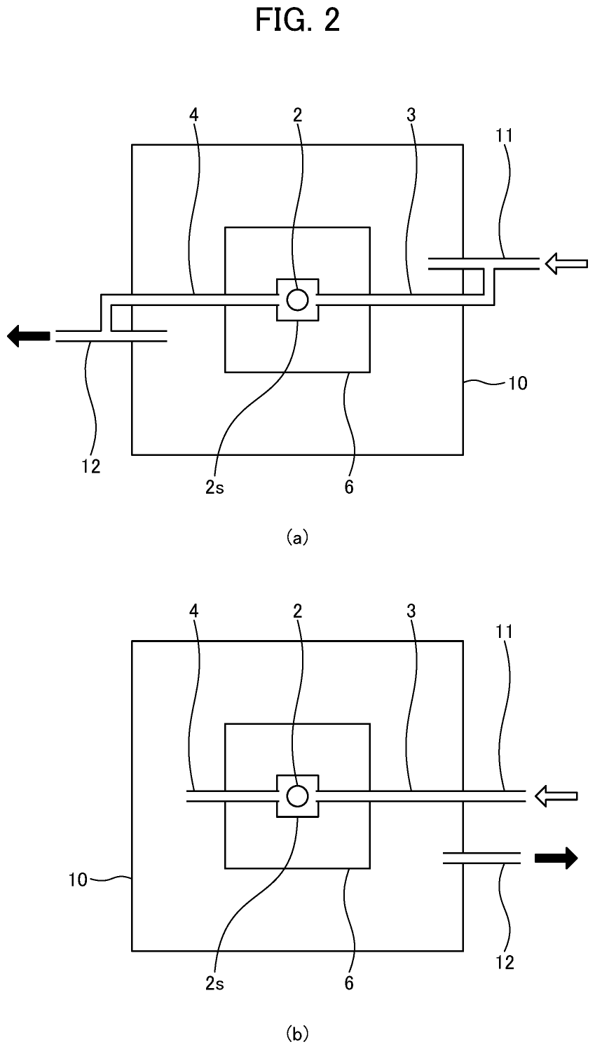

FIG. 2 is a schematic diagram for exemplifying a configuration of the sensor according to the preferred first embodiment of the present invention. In the example shown in (a) of FIG. 2, a sensor 2s is disposed inside a tank 6 constituting a vaporizer (not shown), and the tank 6 is housed inside a housing 10. A first flow channel 3 branches from a supply flow channel 11 for supplying an inert gas for purging to the inside of the housing 10, and the second flow channel 4 merges into a discharge flow channel 12 for discharging the inert gas for purging. Thereby, it is possible to flow a part of the inert gas through the first flow channel 3 and the second flow channel 4 as the fluid for cooling the sensor element 2.

On the other hand, in the example shown in (b) of FIG. 2, similarly to the above-mentioned example shown in (a) of FIG. 2, the sensor 2s is disposed inside the tank 6, and the tank 6 is housed inside the housing 10. However, in the example shown in (b) of FIG. 2, the supply channel 11 for supplying the inert gas for purging inside the housing 10 is directly connected to the first flow channel 3, and all the inert gas is supplied to the first flow channel 3. Moreover, the fluid which has passed through the position of the sensor 2 is discharged to the inside of the housing 10 from the second flow channel 4 and, after passing through the internal space of the housing 10, is discharged to the outside of the housing 10 from the discharge flow channel 12 for discharging the inert gas for purging. Thereby, it is possible to flow all the inert gas through the first flow channel 3 and the second flow channel 4 as the fluid for cooling the sensor element 2.

As a result of the above, in accordance with this embodiment, it is possible to prevent the configuration of the vaporizer from becoming more complicated and/or to prevent the manufacturing cost of the vaporizer from increasing while making it possible to use a sensor continuously for a long period of time at a temperature exceeding the maximum operating temperature of a sensor element constituting the sensor.

In a preferred first embodiment, the sensor according to the present invention further comprises means for supplying the fluid to the first flow channel. For example, when the fluid is compressed gas filled in a cylinder, the means for supplying the fluid to the first flow channel may be constituted by a pressure reducing valve connected to the cylinder to adjust the pressure of the gas to an appropriate value and piping for continuously supplying the gas to the first flow channel in which the pressure of the gas is held at low pressure. Alternatively, when the fluid is a liquid or a gas with low pressure, the means for supplying the fluid to the first flow channel can be constituted by means such as a pump which forcibly sends the fluid to the first flow channel.

After the fluid supplied to the first flow channel is delivered to the position of the sensor element, the fluid is discharged to the outside from the outlet of the second flow channel. The fluid released to the outside may be directly discharged into the atmosphere, or may be recovered using members such as piping and a vacuum pump. The fluid thus recovered may be disposed of as is, or may be reused after being cooled.

In a preferred first embodiment, the semiconductor sensor according to the present invention comprises a temperature sensor at the position or in the vicinity of the sensor element. In this configuration, by monitoring the temperature of the sensor element using the temperature sensor, it is possible to monitor whether the temperature of the sensor element exceeds the target value.

### Second Embodiment

In a second embodiment, the present invention is an invention of the sensor according to the above-mentioned first embodiment, further comprising a protection tube having one end closed and the other end open, in which the sensor elements are located inside the protection tube. Moreover, the first flow channel is configured so as to deliver the fluid from a position of the above-mentioned other end of the protection tube to a position of an endmost sensor element that is the sensor element closest to the above-mentioned one end of the protection tube among the sensor elements. Furthermore, the second flow channel is configured so as to return the fluid delivered to the position of the endmost sensor element by the first flow channel to the position of the above-mentioned other end. In addition, the sensor elements are located in at least one of the first flow channel or the second flow channel.

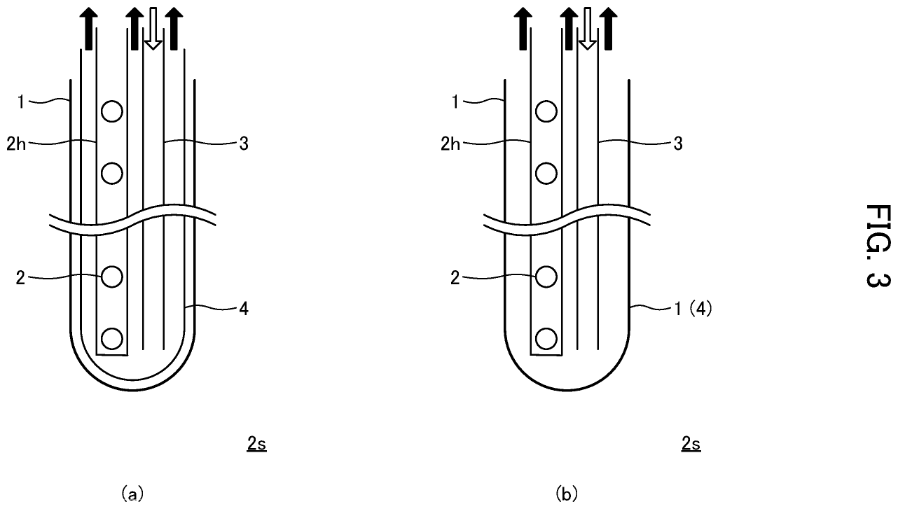

FIG. 3 is a schematic diagram for exemplifying a configuration of a sensor according to a second embodiment of the present invention. The protection tube 1 which the sensor 2s exemplified in (a) of FIG. 3 is a straight tubular member, and the sensor element 2 is located inside the protection tube 1. In the example shown in (a) of FIG. 3, a plurality of the sensor elements 2 are fixed to the surface of the holding member 2h. It is preferable that the protection tube 1 has an internal space sufficient for housing the sensor elements 2 and other members. The protection tube 1 serves to protect the sensor elements 2 by isolating the built-in sensor element 2 from the external environment. One end (lower end in FIG. 3) of the protection tube 1 is closed, and thereby the external environment is prevented from penetrating into the inside of the protection tube 1. The other end (upper end in FIG. 3) of the protection tube 1 is open, and an electrical signal can be transmitted to and received from the sensor element 2 and/or the fluid for cooling the sensor element 2 can be delivered to the position of the sensor element 2 through this open end.

It is preferable that the protection tube 1 according to the second embodiment is made of metal such as stainless steel or other metal, or alloy. Thickness of the tube wall of the protection tube 1 must not be so thin that strength enough for maintaining the shape of the protection tube 1 cannot be ensured, and must not be so thick that it interferes with collecting information on the external environment. It is preferable that the protection tube 1 has a sufficient length such that the position of the sensor element 2 can reach a position where sensing is to be performed.

In the sensor 2s exemplified in (a) of FIG. 3, the first flow channel 3 is configured so as to deliver the fluid from the position of the open end (the above-mentioned other end) of the protection tube 1 to a position of an endmost sensor element that is the sensor element 2 closest to the closed end (the above-mentioned one end) of the protection tube 1 among the sensor elements 2. On the other hand, the second flow channel 4 is configured so as to return the fluid delivered to the position of the endmost sensor element by the first flow channel 3 to the open end (the above-mentioned other end) of the protection tube 1

The first flow channel 3 exemplified in (a) of FIG. 3 delivers the fluid from the position of the open end of the protection tube 1 to the position of the endmost sensor element 2 closest to the closed end of the protection tube 1 among the sensor elements 2. Here, the endmost sensor element closest to the closed end of the protection tube 1 refers to the sensor element located farthest from the open end of the protection tube 1. By delivering the fluid to the position of the endmost sensor element using the first flow channel 3, it becomes possible to cool all the sensor elements 2. The sensor 2s exemplified in (a) of FIG. 3 comprises a plurality of the sensor elements 2. However, when the number of sensor elements 2 is one, it is sufficient that the first flow channel 3 guides the fluid to the position of that one sensor element.

As mentioned above, the first flow channel 3 does not need to reach the sensor element 2, and it is sufficient that the flow of the fluid discharged from the first flow channel 3 reaches the sensor element 2 to attain a cooling effect. Moreover, in the second embodiment, the sensor elements are located in at least one of the first flow channel and the second flow channel. When the endmost sensor element is located in the second flow channel 4, the fluid delivered through the first flow channel 3 to a position close to the closed end of the protection tube 1 may be thereafter entered into the second flow channel 4 and reach the endmost sensor element inside the second flow channel 4 to provide cooling. Such a case where the entire first flow channel and a portion of the second flow channel cooperate to deliver the fluid to the endmost sensor element is also included in the embodiments of the first flow channel in the present invention.

As mentioned above, the second flow channel according to the present invention is a flow channel which returns the fluid delivered to the position of the sensor element by the first flow channel to the outside of the sensor. The second flow channel according to the second embodiment returns the fluid delivered to the position of the endmost sensor element by the first flow channel to the position of the open end of the protection tube. Since one side of the protection tube is closed, the fluid which has been delivered to the position of the endmost sensor element through the first flow channel needs to be returned to the outside of the protection tube. The second flow channel functions as a path for returning the fluid to the outside of the protection tube. Due to the action of the first flow channel and the second flow channel, heat is removed from the sensor elements by the fluid as a heat medium, and the heat is released to the outside of the protection tube.

As mentioned above, either one or both of the first flow channel and the second flow channel according to the present invention may be constituted by an independent tubular member, or the first flow channel and the second flow channel may be constituted integrally by a single member. Alternatively, either the first flow channel or the second flow channel may be constituted by the inner wall of the protection tube.

In the sensor 2s exemplified in (a) of FIG. 3, the second flow channel 4 in a shape of a bottomed cylinder with one end closed and the other end open is housed inside the protection tube 1 in a state where the closed end of the second flow channel 4 faces toward the closed end of the protection tube 1. Furthermore, a plurality of the sensor elements 2 fixed to the holding member 2h and the cylindrical first flow channel 3 are housed inside the second flow channel 4, and the endmost sensor element 2 and the first flow channel 3 are arranged close to each other in the vicinity of the bottom of the protection tube 1. Therefore, in the sensor 2s exemplified in (a) of FIG. 3, the fluid supplied to the upstream end of the first flow channel 3 as shown by the outlined white arrow flows out from the downstream end the first flow channel 3 to the bottom of the second flow channel 4. Among the plurality of the sensor elements 2, the endmost sensor element 2 existing in the vicinity of the bottom of the second flow channel 4 (namely, in the vicinity of the closed end of the protection tube 1) is first cooled by the fluid. Thereafter, as the fluid flows to the downstream side (the upper side in FIG. 3) along the second flow channel 4, other sensor elements 2 are also cooled by contacting the fluid, and the fluid is discharged from the downstream end (the upper end in FIG. 3) of the second flow channel 4 to the outside of sensor 2s as shown by the black arrows.

On the other hand, the sensor 2s exemplified in (b) of FIG. 3 has a different configuration from the above-mentioned sensor 2s exemplified in (a) of FIG. 3 in that the second flow channel 4 as an independent member is not housed inside the protection tube 1 and the sensor 2s does not comprise the second flow channel 4 as an independent member. In the sensor 2s exemplified in (b) of FIG. 3, the fluid supplied to the upstream end of the first flow channel 3 as shown by the outlined white arrow flows out from the downstream end the first flow channel 3 to the bottom of the protection tube 1. Among the plurality of the sensor elements 2, the endmost sensor element 2 existing in the vicinity of the bottom of the protection tube 1 (namely, in the vicinity of the closed end of the protection tube 1) is first cooled by the fluid. Thereafter, as the fluid flows to the downstream side (the upper side in FIG. 3) along the internal space of the protection tube 1, other sensor elements 2 are also cooled by contacting the fluid, and the fluid is discharged from the open end (the upper end in FIG. 3) of protection tube 1 to the outside of sensor 2s as shown by the black arrows. Namely, in the example shown in (b) of FIG. 3, the internal space of the protection tube 1 functions as the second flow channel 4.

Although all the sensor elements were located in the second flow channel in the example shown in FIG. 3, the sensor elements are located in at least one of the first flow channel or the second flow channel in the sensor according to the second embodiment as mentioned above. Here, “the sensor elements are located in at least one of the first flow channel or the second flow channel” refers to a state where all the sensor elements including the endmost sensor element exist inside the first flow channel or the second flow channel and the surfaces of the sensor elements or their housing are in contact with the fluid flowing in the first flow channel or the second flow channel and heat is removed. In the second embodiment, all the sensor elements are located in at least one of the first flow channel or the second flow channel, and there is no sensor elements located in neither the first flow channel nor the second flow channel. When two or more sensor elements exist, all the sensor elements may be located only in either one of the first flow channel or the second flow channel, or the sensor elements may be distributed and located in both the first flow channel and the second flow channel.

In the sensor according to a preferred second embodiment, at least one of a member constituting the first flow channel and a member constituting the second flow channel is formed of a material having lower thermal conductivity than thermal conductivity of a member constituting the protection tube. As mentioned above, the fluid flowing through the first flow channel and the second flow channel functions as a heat medium which suppresses the temperature rise of the sensor element. However, since the temperature outside the protection tube is higher than the temperature of the fluid, there is a risk that the fluid may be heated by heat from the outside of the protection tube and the temperature of the fluid may rise before the fluid is delivered to the sensor element. When at least one of the members constituting the first flow channel and the second flow channel is made of a material having lower thermal conductivity than that of the member constituting the protection tube, since it becomes harder for the heat from the outside of the protection tube to be transmitted to the fluid, the temperature of the fluid is prevented from rising and the fluid can perform its original cooling function.

In this preferred second embodiment, the material constituting at least one of the members constituting the first flow channel and the second flow channel may be any material as long as the material has lower thermal conductivity than that of the member constituting the protection tube. For example, when the protection tube is formed of metal or alloy as mentioned above, a rise in the temperature of the fluid can be suppressed by forming at least one of the first flow channel and the second flow channel of fluororesin such as polytetrafluoroethylene or other material having lower thermal conductivity than that of the protection tube. In at least one of the first flow channel and the second flow channel, the entire flow channel may be formed of a material having lower thermal conductivity than that of the protection tube, or a portion of the flow channel may be formed of a material having lower thermal conductivity than that of the protection tube. For example, in a case where the flow channel is constituted by a plurality of members, even when some of those members have higher thermal conductivity than that of the member constituting the protection tube, the rise in the temperature of the fluid in the entire flow channel can be suppressed if the thermal conductivity of other members is low.

In this preferred second embodiment, the first flow channel and the second flow channel themselves may be formed of a material having low thermal conductivity. Alternatively, the flow channel may have a structure in which a plurality of tubes are stacked in layers, and a material having low thermal conductivity may be used for some of the layers. Alternatively, the protection tube may have a double structure consisting of an outer tube and an inner tube, and the gap between the two tubes may be vacuum. This space held in a vacuum state is one of the embodiments of the “material having lower thermal conductivity than thermal conductivity of the member constituting the protection tube” in the present invention. Furthermore, the protection tube may have a double structure consisting of an outer tube and an inner tube, and the material constituting at least one of the members constituting the first flow channel and the second flow channel may have lower thermal conductivity than that of the member constituting the protection tube.

In the sensor according to a preferred second embodiment of the present invention, the first flow channel is located inside the second flow channel. Here, “the first flow channel is located inside the second flow channel” means that the member constituting the first flow channel exists at a position inside the member constituting the second flow channel in the cross section of the protection tube and is in contact with the fluid flowing through the second flow channel. In this configuration, fluid is first delivered through the first flow channel located inside the second flow channel to the position of the endmost sensor element, and thereafter the fluid is returned to the open end of the protection tube through the second flow channel. Since all the sensor elements including the endmost sensor element are located in at least one of the first flow channel or the second flow channel, they come into contact with the fluid flowing through these flow channels. In this configuration, since the outside of the first flow channel is surrounded by the fluid flowing through the second flow channel, the heat outside the protection tube is not directly transmitted to the fluid flowing through the first flow channel. Thereby, since the temperature rise of the fluid flowing through the first flow channel, the effect of cooling the sensor element by the fluid is increased. In addition, as mentioned above, in the sensor 2s exemplified in (a) of FIG. 3, the first flow channel 3 is located inside the second flow channel 4. Namely, the sensor 2s exemplified in (a) of FIG. 3 satisfies the requirements as the sensor according to this preferred embodiment.

### Third Embodiment

In a third embodiment, the present invention is an invention of a liquid level sensor used in a vaporizer, which comprises a protection tube having one end closed and the other end open and installed so as to extend vertically, one, two or more sensor elements located inside the protection tube, a first flow channel that is a flow channel configured so as to deliver the fluid from a position of the above-mentioned other end (open end) of the protection tube to a position of an endmost sensor element that is the sensor element closest to the above-mentioned one end (closed end) of the protection tube among the sensor elements, a second flow channel that is a flow channel configured so as to return the fluid delivered to the position of the endmost sensor element by the first flow channel to the position of the above-mentioned other end (open end) of the protection tube, and a float comprising a magnet and configured so as to move along the protection tube in association with fluctuations in the liquid level of a precursor which becomes a gas by being vaporized by the vaporizer, wherein the sensor elements are located in at least one of the first flow channel or the second flow channel, and the fluid is not a gas obtained by vaporizing the above-mentioned precursor with the vaporizer.

In this embodiment, the protection tube is installed vertically and arranged such that its longitudinal direction coincides with a direction perpendicular to the liquid surface of the liquid whose level is to be determined (the precursor of the material gas to be supplied by the vaporizer). A float comprising a magnet moves along the protection tube in association with fluctuations in the liquid level. The sensor element turns on and off in response to the magnetic field generated by the magnet. By detecting this as an electrical signal, it is possible to know the position of the liquid surface where the float exists. As specific examples of such a sensor element, Hall ICs and reed switches can be exemplified, for example. However, the sensor element used in this embodiment is not particularly limited as long as it can determine the position of the liquid surface where the float exists by outputting a signal corresponding to the magnetic field generated by the magnet.

The action when the fluid flows through the first flow channel and the second flow channel in this embodiment is the same as the action in the first embodiment and the second embodiment, and the action is to prevent malfunctions and/or acceleration of aging deterioration due to temperature rise of the sensor elements by maintaining the temperature of all the sensor elements including the endmost sensor element at a temperature lower than the temperature outside the protection tube. Since preferred embodiments of the protection tube, the first flow channel, the second flow channel and the like in the third embodiment are the same as those in the second embodiment, explanation thereof will be omitted here.

The liquid level sensor according to the third embodiment can be used as a liquid level sensor for a tank which a vaporizer comprises. As mentioned above, when a method of heating a liquid material (precursor) stored in a tank is used to vaporize a material gas in a vaporizer, it is general that the liquid level sensor in contact with the liquid material in the tank is also heated to the same temperature as that of the liquid material. In some liquid materials among the liquid materials, vapor pressure necessary for supplying material gas cannot be obtained unless they are heated to a temperature exceeding the maximum operating temperature of the sensor element (for example, 100° C.). By using the liquid level sensor according to the third embodiment, even when the liquid material is heated to a temperature exceeding the maximum operating temperature of the sensor element, the temperature of the sensor element can be maintained at a temperature lower than the temperature of the liquid material. Therefore, the vapor pressure of the material gas can be increased while ensuring the long-term reliability of the sensor.

Although the above-mentioned third embodiment is an embodiment limited to a liquid level sensor, embodiments of the present invention are not limited to a liquid level sensor. The effects of the present invention can also be obtained even when the semiconductor sensor in the first embodiment is replaced with an optical sensor, a magnetic field sensor, a pressure sensor, an acceleration sensor and the like, without departing from the gist of the present invention.

### WORKING EXAMPLES

About a liquid level sensor used in a vaporizer as an example of an embodiment of the present invention, explanation will be given below referring to drawings. It should be noted that the following explanation is merely to exemplify the embodiment of the present invention and the present invention is not limited to the scope of the example shown below.

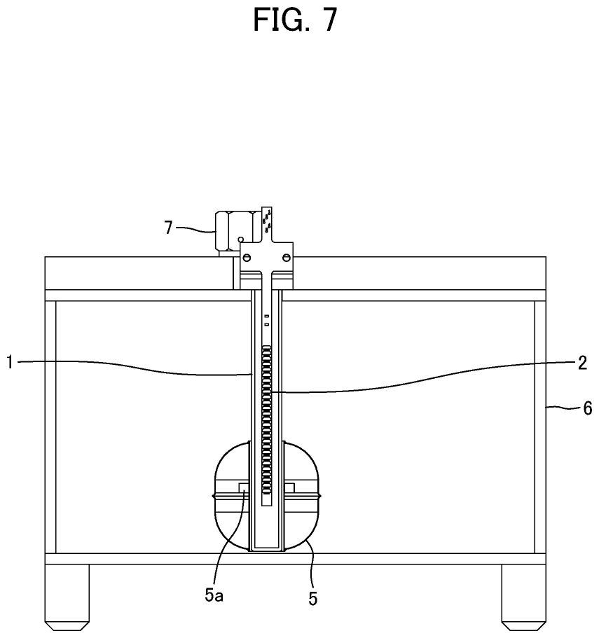

FIG. 7 is a partial cross-sectional view for showing an example of a liquid level sensor according to the prior art disclosed in Patent Literature 1. This liquid level sensor comprises a protection tube 1 which is entirely disposed inside a tank 6, has one end closed and the other end open and is installed so as to extend vertically; two or more Hall ICs (semiconductor elements) 2 having a pn junction and located inside the protection tube 1, and a float 5 comprising a magnet 5a and configured so as to move along the protection tube in association with fluctuations in the liquid level. The inside of the tank 6 is filled with a liquid material and the liquid material is vaporized to generate gas by heating the liquid material with a heater (not shown). Namely, the liquid material is a precursor of a material gas to be supplied by the vaporizer. The temperature of the liquid material is measured by a temperature sensor 7. However, in FIG. 7, only a port for inserting the tip of the temperature sensor 7 into the inside of the tank 6 is shown. The generated gas accumulates in a space above the liquid level inside the tank 6. The gas stored inside the tank 6 can be taken out to the outside of the tank 6 using piping (not shown) to be used for various purposes.

The Hall ICs (semiconductor elements) 2 are configured to ground a connection point of a resistor array consisting of a plurality of resistors connected in series. The resistance value of the resistor array changes by the Hall IC (semiconductor element) 2 acting due to the magnetic field generated by the magnet 5a. By taking out an electrical signal corresponding to this resistance value, the position of the liquid surface of the liquid material can be detected.

In the vaporizer having the structure shown in FIG. 7, the protection tube 1 is formed of stainless steel. Air exists around the Hall ICs (semiconductor elements) 2 inside the protection tube 1. The liquid material stored in tank 6 is heated for the purpose of generating gas. When the temperature of the liquid material rises, first the temperature of the outer wall of the protection tube 1 in contact with the liquid material rises, and the heat is transmitted to the inner wall of the protection tube 1 by conduction. Next, the heat is transferred from the inner wall of the protection tube 1 toward the Hall ICs (semiconductor elements) 2 by conduction, air convection and electromagnetic radiation.

The closed end of the protection tube 1 is inserted deeply below the liquid level of the tank 6, and the circumference of the protection tube 1 is filled with the heated liquid material. Since the cross-sectional area of the protection tube 1 is smaller than the area of the outer peripheral surface, the amount of heat emitted from the Hall ICs (semiconductor elements) 2 located inside the protection tube 1 to the outside through the space on the inner diameter side of the protection tube 1 is smaller than the amount of heat transmitted from the outside toward the inside of the protection tube 1. Therefore, the temperature of the Hall ICs (semiconductor elements) 2 when the thermal equilibrium state is attained has risen to approximately the same temperature as the liquid material. For this reason, in the vaporizer according to the prior art shown in FIG. 7, it was not possible to raise the temperature of the liquid material to a temperature exceeding the maximum operating temperature (100° C.) of the Hall ICs (semiconductor elements) 2.

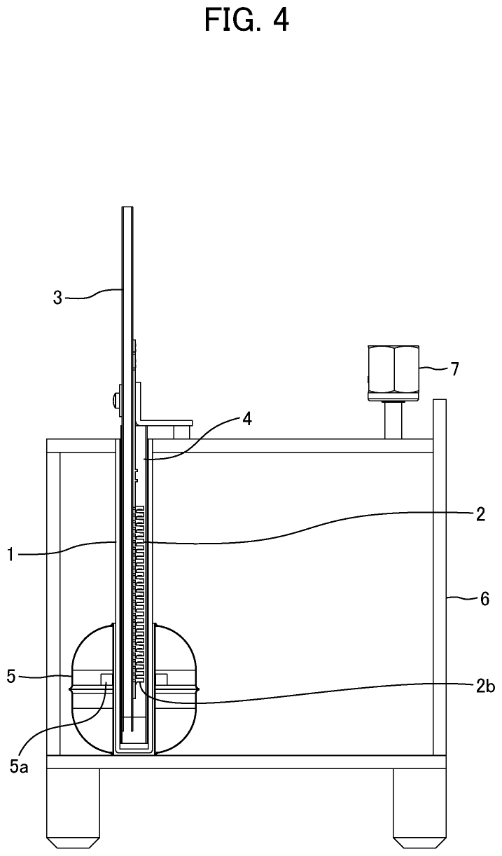

FIG. 4 is a partial cross-sectional view for showing an example of the structure of a liquid level sensor according to the present invention. The basic configuration of this liquid level sensor is the same as that of the prior art vaporizer shown in FIG. 7. Namely, the liquid level sensor exemplified in FIG. 4 comprises a protection tube 1 made of stainless steel, which is entirely disposed inside a tank 6, has one end closed and the other end open and installed so as to extend vertically; two or more Hall ICs (semiconductor elements) 2 having a pn junction and located inside the protection tube 1, and a float 5 comprising a magnet 5a and configured so as to move along the protection tube 1 in association with fluctuations in the liquid level. In addition to the above-mentioned configuration, the liquid level sensor according to the present invention further comprises a first flow channel 3 which delivers fluid from the position of the open end of the protection tube 1 to the position of the endmost Hall IC (semiconductor element) 2b closest to the closed end of the protection tube 1 among the Hall ICs (semiconductor elements) 2 and a second flow channel 4 which returns the fluid delivered to the position of the endmost Hall IC (semiconductor element) 2b to the open end of the protection tube 1. As in the case of FIG. 7, also in FIG. 4, only the port for the temperature sensor 7 is shown.

In FIG. 4, the first flow channel 3 is located inside the second flow channel 4. Namely, in FIG. 4, the first flow channel 3 is constituted by a thin tube having an outer diameter sufficiently smaller than the inner diameter of the protection tube 1, and is installed so as to extend vertically from the open end to the closed end of the protection tube 1. The position of the end on the fluid outlet side that is the lower side of the first flow channel 3 is located below the position of the Hall IC closest to the closed end of the protection tube 1 among the Hall ICs (semiconductor elements 2 (endmost sensor element 2b). No Hall IC is located inside the first flow channel 3.

In FIG. 4, the space inside the protection tube 1 from the lower tip of the first flow channel 3 to the open end of the protection tube 1 excluding the first flow channel 3 constitutes the second flow channel 4. All Hall ICs (semiconductor elements) 2 are located in the second flow channel 4. Although omitted in FIG. 4, the liquid level sensor shown in FIG. 4 comprises means for supplying the fluid to the first flow channel 3.

In order to operate the liquid level sensor according to the present invention shown in FIG. 4, first, the fluid is supplied from the upper end of the first flow channel 3 using the supply means (not shown). The supplied fluid goes down through the inside of the first flow channel 3 and thereafter flows out from the lower tip into the second flow channel 4 that is the inside of the protection tube 1. Next, the fluid goes upward through the second flow channel 4 while contacting with the array of the Hall ICs (semiconductor elements) 2, and is discharged to the outside from the open end of the protection tube 1.

In the liquid level sensor according to the present invention shown in FIG. 4, as mentioned above, the fluid flows inside the protection tube 1. Since the fluid flowing inside the protection tube 1 does not stay in one place but always flows, even when the heat of the liquid material reaches the inner wall of the protection tube 1, there is no heat transfer path through which the heat is further transferred to the Hall ICs (semiconductor elements) 2. Moreover, since the fluid flowing through the first flow channel 3 is surrounded by the fluid returning through the second flow channel 4, the temperature of the fluid flowing through the first flow channel 3 will never rise due to the heat of the heated liquid material. Furthermore, since substance which is the fluid moves, the system will never reach a state of thermal equilibrium. Due to these actions, in accordance with the liquid level sensor according to the present invention shown in FIG. 4, the temperature of the Hall ICs (semiconductor elements) 2 can be maintained at a temperature lower than the temperature of the liquid material.

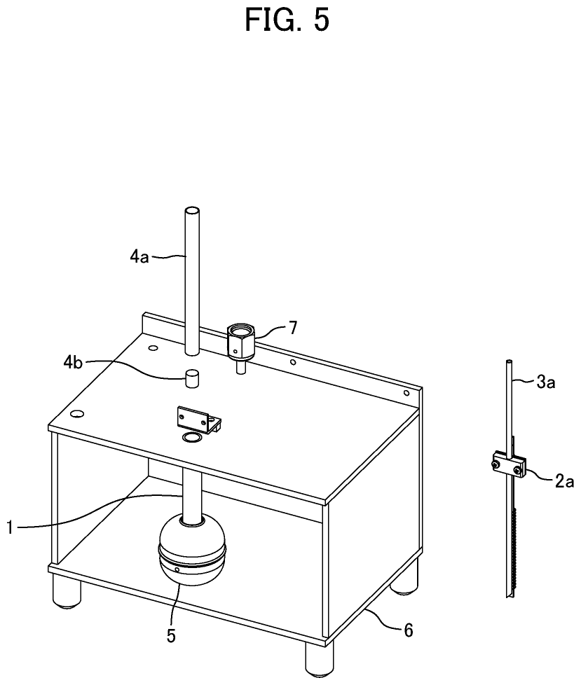

FIG. 5 is an erection diagram of a vaporizer comprising the liquid level sensor exemplified in FIG. 4. In FIG. 5, a sleeve 4a with an outer diameter of 10.0 mm and an inner diameter of 9.0 mm and a plug with an outer diameter of 9.0 mm for closing the tip of the sleeve 4a are illustrated above a stainless steel protection tube 1 with an inner diameter of 10.8 mm. For assembling them, first, the plug 4b is inserted into the lower end of the sleeve 4a, and then the sleeve 4a is inserted into the protection tube 1 until the lower end of then the sleeve 4a comes into contact with the closed end of the protection tube 1. The inner diameter of this sleeve 4a corresponds to the outer diameter of the second flow channel 4. Next, a printed wiring board 2a on which arrays of the Hall ICs (semiconductor elements) 2 and resistors are arranged and an elongated thin (narrow) tube 3a constituting the first flow channel 3 are fixed to each other and inserted inside the sleeve 4a of the protection tube 1, and then they are fixed with a fixture.

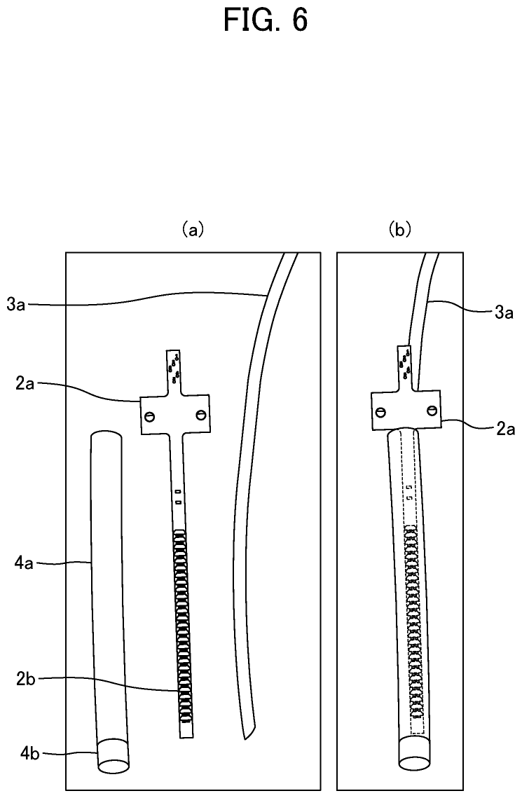

FIG. 6 is a front view for explaining a state where the sleeve 4a, the plug 4b, the printed wiring board 2a and the thin tube 3a constituting the first flow path 3 are assembled. In (a) of FIG. 6, the plug 4b is inserted in the lower end of the sleeve 4a. This is to prevent the fluid supplied to the lower end of the sleeve 4a through the first flow path 3 from entering the gap between the inner diameter of the protection tube 1 and the outer diameter of the sleeve 4a. Both the thin tube 3a constituting the first flow path 3 and the sleeve 4a constituting the second flow path 4 are formed of fluororesin having low thermal conductivity. The plug 4b is formed of a silicone resin sponge. In (b) of FIG. 6, the lower end of the printed wiring board 2a is inserted in the sleeve 4a, and the thin tube 3a constituting the first flow path 3 is also inserted in the sleeve 4a.

In an assembled state as shown in (b) of FIG. 6, since the fluid which went down through the first flow channel 3 is discharged from the tip of the thin tube 3a into the inside of the sleeve 4a and is prevented from going down by the plug 4b, the fluid goes upward. As shown in (a) of FIG. 6, since the lower end of the thin tube 3a constituting the first flow channel 3 is cut diagonally, even when the tip of the thin tube 3a is in contact with the plug 4b, the fluid will never be hindered by the plug 4b from being released. The fluid going upward through the sleeve 4a is first delivered to the position of the endmost Hall IC (endmost sensor element) 2b, thereafter comes into contact with other Hall ICs 2 one after another, and finally reaches the open end of the protection tube 1 to be released to the outside.

In this configuration, since the sleeve 4a constituting the outer wall of the second flow channel 4 is formed of fluororesin with low thermal conductivity, the heat on the inner wall of the protection tube 1 is not easily transmitted to the fluid flowing through the second flow channel 4. Furthermore, since the thin tube 3a of the first flow channel 3 located inside the second flow channel 4 is also formed of fluororesin and the plug 4b which closes the tip of the sleeve 4a is formed of silicone resin, the heat is hardly transferred from the protection tube 1 to the fluid flowing through the flow channel 3. Therefore, the temperature of the fluid delivered to the endmost Hall IC 2b is almost the same as the temperature of the fluid supplied to the first flow channel 3.

TABLE 1

| With Sleeve and Plug | | | | Without Sleeve and Plug | | | |
|---|---|---|---|---|---|---|---|
| Flow | | Protection | | Flow | | Protection | |
| Rate | Tank | Tube | Hall IC | Rate | Tank | Tube | Hall IC |
| [slm] | [° C.] | [° C.] | [° C.] | [slm] | [° C.] | [° C.] | [° C.] |
| 0 | 110 | 92.8 | 93.2 | 0 | 110 | 96.5 | 96.8 |
| 1.1 | 110 | 90.0 | 85.1 | 1.2 | 110 | 93.6 | 86.3 |
| 2.6 | 110 | 84.3 | 64.4 | 2.5 | 110 | 87.3 | 70.3 |
| 3.6 | 110 | 81.3 | 56.7 | 3.7 | 110 | 83.1 | 62.1 |

In Table 1, data for showing the relations between the flow rate of nitrogen gas and the temperatures of respective parts when nitrogen gas at room temperature is supplied to the first flow channel 3 while heating the bottom of the tank 6 of the vaporizer shown in FIG. 4 by a heater (not shown) in a state where the tank 6 is empty and controlling the temperature detected by the temperature sensor 7 installed inside the tank 6 at 110° C. are listed. The temperatures are measured at two locations, namely on the inner diameter side of the protection tube 1 close to the open end, and on the inner diameter side of the protection tube 1 near the open end of the protection tube 1 and on the Hall IC (semiconductor element) 2 closest to the open end of the protection tube 1 in the array of the Hall ICs (semiconductor elements) 2. The temperatures were measured approximately 10 minutes after the flow rate of nitrogen gas stabilized in a state where the temperature of the respective parts were stabilized.

In the left columns of Table 1, temperature data when the sleeve 4a and plug 4b shown in FIG. 5 and FIG. 6 were used are shown. In accordance with this, when the flow rate of nitrogen gas was zero, the temperature of the protection tube 1 and the temperature of the Hall IC (semiconductor element) 2 were almost equal to each other, and both exceeded 90° C. When nitrogen gas was flowed, the higher the flow rate becomes, the lower the temperatures at the respective parts become and the larger the temperature differences between the two positions becomes. From these results, even when the temperature of the tank 6 exceeds 100° C., the temperature of the Hall ICs (semiconductor elements) 2 can be maintained at a lower temperature by using the liquid level sensor according to the present invention. Moreover, it can be found that not only the temperature of the Hall ICs (semiconductor elements) 2 but also the temperature of the protection tube 1 is lowered by flowing nitrogen gas.

In the right columns of Table 1, temperature data when neither the sleeve 4a nor plug 4b shown in FIGS. 5 and 6 were used are shown. At the same flow rate of nitrogen gas, when the sleeve 4a and plug 4b were not used, the temperature drops in the respective parts were smaller and the temperature differences were also smaller as compared with the case where the both were used. From this, it can be found that the effect of cooling the Hall ICs 2 according to the present invention is higher when the outer wall of the second flow channel 4 is constituted by the inner wall of the sleeve 4a which has low thermal conductivity, as compared with the case where the outer wall of the second flow channel 4 is constituted by the inner wall of the protection tube 1.

TABLE 2

| With Sleeve and Plug | | | | With Sleeve, Without Plug | | | |
|---|---|---|---|---|---|---|---|
| Flow | | Protection | | Flow | | Protection | |
| Rate | Tank | Tube | Hall IC | Rate | Tank | Tube | Hall IC |
| [slm] | [° C.] | [° C.] | [° C.] | [slm] | [° C.] | [° C.] | [° C.] |
| 0 | 140 | 136.0 | 137.6 | 0 | 140 | 124.8 | 125.8 |
| 1.4 | 140 | 131.1 | 127.8 | 1.3 | 140 | 124.4 | 114.1 |
| 2.4 | 140 | 124.8 | 110.0 | 2.5 | 140 | 119.2 | 96.2 |
| 3.7 | 140 | 118.4 | 94.2 | 3.7 | 140 | 115.4 | 82.3 |
| 4.8 | 140 | 113.9 | 85.2 | 4.8 | 140 | 112.6 | 72.9 |

In Table 2, data for showing the relations between the flow rate of nitrogen gas and the temperatures of respective parts when controlling the temperature detected by the temperature sensor 7 installed inside the tank 6 at 140° C. in apparatus having the same configuration as in the case of Table 1. In the left columns of Table 2, temperature data when the sleeve 4a and plug 4b shown in FIGS. 5 and 6 were used are shown. In accordance with this, it can be found that, even when the temperature of the tank 6 is 140° C., the temperature of the Hall IC (semiconductor element) 2 can be cooled to lower than 100° C. by flowing nitrogen gas at a flow rate of 3.7 slm (standard liters per minute) or more. On the other hand, in the configuration shown on the right side of Table 2, in which the sleeve was used, but the plug was not used, it was found that the cooling effect by nitrogen gas was increased as compared with the case where the sleeve 4a and plug 4b were used. It can be considered that this is because the transfer of heat from the outside to the inside of the protection tube 1 is more surely interrupted since a part of the nitrogen gas supplied to the tip of the first flow channel 3 enters the gap between the protection tube 1 and the outer wall of the sleeve 4a due to the lack of the plug 4b and the remaining nitrogen gas cools the Hall ICs (semiconductor elements) 2 while going upward inside the sleeve 4a. Namely, in this case, the second flow channel 4 is branched into two systems.

In addition, in the above-mentioned working examples, since the amount of heat released from the inside of the tank 6 to the outside through the protection tube 1 increases as the flow rate of nitrogen gas supplied to the first flow channel increases, it was necessary to increase the output of the heater in order to maintain the temperature inside the tank 6. However, in accordance with the data in Table 1 and Table 2, the temperature of the tank 6 is maintained at the set temperatures even when the flow rate of nitrogen gas is the maximum. From this, it can be found that, even when the liquid level sensor according to the present invention is applied to a vaporizer according to the prior art, there is no need to replace the heater with one having a higher heating capacity, and the conventional heater can be used as is.

In accordance with the embodiments of the present invention as explained above, an applicable temperature range of a liquid level sensor can be expanded to a higher temperature side by simply adding the first flow channel, the second flow channel and the fluid supply means without substantially changing a structure of the liquid level sensor according to the prior art shown in FIG. 7.

1-9. (canceled)

10. A sensor used in a vaporizer, comprising:
one, two or more sensor elements,
a first flow channel that is a flow channel which delivers fluid from the outside of said sensor to a position of said sensor element, and
a second flow channel that is a flow channel which returns said fluid delivered to said position of said sensor element by said first flow channel to the outside of said sensor, and
among members constituting said vaporizer, at least a member in which said sensor is disposed is housed inside a housing,
said vaporizer is configured such that the inside of said housing is purged by flowing an inert gas inside said housing, and
said sensor is configured such that at least a part of said inert gas flows through said first flow channel and said second flow channel as said fluid.

11. The sensor according to claim 10, wherein:
said sensor element is a semiconductor element having a pn junction.

12. The sensor according to claim 11, wherein:
said semiconductor element is a Hall IC.

13. The sensor according to claim 10, wherein:
said sensor element is a reed switch.

14. A sensor used in a vaporizer, comprising:
one, two or more sensor elements,
a first flow channel that is a flow channel which delivers fluid from the outside of said sensor to a position of said sensor element, and
a second flow channel that is a flow channel which returns said fluid delivered to said position of said sensor element by said first flow channel to the outside of said sensor, and
said fluid is not a gas obtained by vaporizing a precursor with said vaporizer,
said sensor further comprises a protection tube having one end closed and the other end open,
said sensor elements are located inside said protection tube,
said first flow channel is configured so as to deliver said fluid from a position of said other end of said protection tube to a position of an endmost sensor element that is said sensor element closest to said one end of said protection tube among said sensor elements,
said second flow channel is configured so as to return said fluid delivered to the position of said endmost sensor element by said first flow channel to the position of said other end, and
said sensor elements are located in at least one of said first flow channel or said second flow channel,
both of a member constituting said first flow channel and a member constituting said second flow channel are formed of a material having lower thermal conductivity than thermal conductivity of a member constituting said protection tube,
said first flow channel is located inside said second flow channel, and
said protection tube does not constitute a flow channel of the fluid.

15. The sensor according to claim 14, wherein:
said sensor element is a semiconductor element having a pn junction.

16. The sensor according to claim 15, wherein:
said semiconductor element is a Hall IC.

17. The sensor according to claim 14, wherein:
said sensor element is a reed switch.

18. A liquid level sensor used in a vaporizer, which comprises:
a protection tube having one end closed and the other end open and installed so as to extend vertically,
one, two or more sensor elements located inside said protection tube,
a first flow channel that is a flow channel configured so as to deliver fluid from a position of said other end of said protection tube to a position of an endmost sensor element that is said sensor element closest to said one end of said protection tube among said sensor elements,
a second flow channel that is a flow channel configured so as to return said fluid delivered to the position of said endmost sensor element by said first flow channel to the position of said other end of said protection tube, and
a float comprising a magnet and configured so as to move along said protection tube in association with fluctuations in the liquid level of a precursor which becomes a gas by being vaporized by said vaporizer,
wherein:
said sensor elements are located in at least one of said first flow channel or said second flow channel, and
among members constituting said vaporizer, at least a member in which said sensor is disposed is housed inside a housing,
said vaporizer is configured such that the inside of said housing is purged by flowing an inert gas inside said housing, and
said sensor is configured such that at least a part of said inert gas flows through said first flow channel and said second flow channel as said fluid.

19. The liquid level sensor according to claim 18, wherein:
said sensor element is a Hall IC.

20. The liquid level sensor according to claim 18, wherein:
said sensor element is a reed switch.

21. A liquid level sensor used in a vaporizer, which comprises:
a protection tube having one end closed and the other end open and installed so as to extend vertically,
one, two or more sensor elements located inside said protection tube,
a first flow channel that is a flow channel configured so as to deliver fluid from a position of said other end of said protection tube to a position of an endmost sensor element that is said sensor element closest to said one end of said protection tube among said sensor elements,
a second flow channel that is a flow channel configured so as to return said fluid delivered to the position of said endmost sensor element by said first flow channel to the position of said other end of said protection tube, and
a float comprising a magnet and configured so as to move along said protection tube in association with fluctuations in the liquid level of a precursor which becomes a gas by being vaporized by said vaporizer,
wherein:
said sensor elements are located in at least one of said first flow channel or said second flow channel, and
said fluid is not a gas obtained by vaporizing said precursor with said vaporizer,
both of a member constituting said first flow channel and a member constituting said second flow channel are formed of a material having lower thermal conductivity than thermal conductivity of a member constituting said protection tube,
said first flow channel is located inside said second flow channel, and
said protection tube does not constitute a flow channel of the fluid.

22. The liquid level sensor according to claim 21, wherein:
said sensor element is a Hall IC.

23. The liquid level sensor according to claim 21, wherein:
said sensor element is a reed switch.
